(19) United States
(12) Patent Application Publication
(10) Pub. No.: US 2004/0111800 A1
(43) Pub. Date: Jun. 17, 2004

(54) Patient gurney for use with multiple, different patient support boards

(76) Inventors: Frank Bartels, Seybothenreuth (DE); Michael Heinold, Speichersdorf (DE)

Correspondence Address: SCHIFF HARDIN, LLP, PATENT DEPARTMENT, 6600 SEARS TOWER, CHICAGO, IL, 60606-6473, US

(21) Appl. No.: 10/645,286

(22) Filed: Aug. 21, 2003

(30) Foreign Application Priority Data
Aug. 21, 2002 (DE) 102 38 296.4

(51) Int. Cl. A61G 13/00

(52) U.S. Cl. 5/600; 5/81.1 R

(57) ABSTRACT

A gurney for transporting a patient has a chassis that has a support component that supports a supporting board for a patient. Upon placement on the support component, the board is subsequently fastened with a positive fit to prevent lateral motion, and the board can be removed by means of a medical treatment or examination device. The support component allows at least two different boards to be alternately supported and fastened with a positive fit at their head ends. The boards are different from one another at their head ends on the underside in shape and/or in width.

### BACKGROUND OF THE INVENTION

1. Field of the Invention

The present invention concerns a gurney to transport a patient, of the type having a chassis with a support component that supports a board for the patient, wherein the board, upon placement on the support component, is prevented from lateral motion due to positive fit, and whereby the board to bear the patent during an examination or a treatment can be detached by means of a medical device that conducts the examination of treatment.

2. Description of the Prior Art

A gurney of this type is known, for example, from German PS 42 24 036, U.S. Pat. No. 5,014,968, British Specification 961 677 and German OS 199 47 361. The German OS 101 13 855 (published after the German application on which convention priority is based) also discloses such a gurney.

In a large hospital, a number of medical examination devices that are distinct from one another and/or therapy devices that are distinct from one another are usually present. Each examination and/or treatment device has a specific stationary patient support device with a matching bearing plate belonging thereto that is mounted immovably or movably on a base. For example, bearing plates or support boards for computed tomography systems are slightly curved on the underside in conformity to the rotation geometry. Support boards exist for angiographic examinations that, for reasons of accessibility, taper at the head end, i.e. the width at the head end approximately corresponds to the diameter of a human head. The patient rests on the support board during the examination or treatment. In order to insert the patient into the examination or treatment area of the particular examination and/or treatment device, for example into the tunnel of a magnetic resonance tomography apparatus, the support board is movably seated or directed on the base.

For transport to or from an examination and/or treatment device, a transport cart is used, also referred to as a gurney. The patient is carried on the gurney. A transfer procedure thus is necessary that is time-consuming and physically taxing for the medical personnel. In addition, severely injured patients, for example trauma patients, can suffer additional harm in a transfer procedure. Furthermore, valuable time is lost due to the transfer.

### SUMMARY OF THE INVENTION

An object of the present invention is to provide a gurney in which these disadvantages are avoided or at least alleviated.

This object is inventively achieved in a gurney of the type initially described wherein the support component is fashioned to alternately allow at least two different support boards to be supported sat the head end and to be firmly fastened with a positive fit, the support boards being different from each other in shape at the underside and/or in width at the head end.

The support component is designed such that, in spite of the different shapes of the undersides and/or different widths of the support boards, a positive fit of the underside and/or the side surfaces of each board to the support component always ensues when either board is placed on the component, such that the support board is prevented from lateral motion, in particular from bilateral motion.

The form fit preferably ensues two-dimensionally between the underside or/and the side surfaces of each board on the side and a contact surface on the support component on the other side.

The different boards are support boards of different types, meaning for different types of medical devices. The board types include, for example, a board type for a computed tomography device, a board type for an angiography x-ray device, a board type for an x-ray fluoroscopy or static exposure system, a board type for a therapy device, and/or a board type for a magnetic resonance tomography device.

An advantage of the inventive solution is that the patient, upon transport to or from a medical examination and/or treatment device, can already be positioned on the appropriate board required for the particular examination and/or treatment device and the matching patient support device. In particular, the portion of the hospital or clinic workflow called the intermodalities workflow is thereby simplified. The number of necessary transfer or bed-change events is thereby reduced in a manner advantageous to the hospital personnel. The hospital personnel can ergonomically work more advantageously and less strenuously. Because a number of different boards can be attached to the same gurney, this advantage can be achieved without a particularly large number of different gurneys being required. This means that the probability is high that the hospital personnel will be able to immediately find a suitable gurney at a specific location or examination or treatment room in the hospital, even though a lower number of gurneys may be present.

A further advantage of the invention is that the gurney conforms to the boards that are already present, and not necessarily the reverse. This eases retrofitting.

For example, the gurney is fashioned such that the respective boards can be applied to the gurney at the end of the patient's head, i.e., the support component is located at the head end.

At opposite ends, each board can be coupled to the gurney. Each board can be firmly coupled at its opposite, meaning that in the coupled state, removal and/or movement of the board from or on the gurney is prevented. The coupling can ensue non-positively and/or positively.

In one embodiment, a positive connection is only produced at one end of the gurney between the board and the gurney. A number of advantages follow from this. First, the boards need not be provided at the head end with a coupling mechanism that would possibly have to be manufactured of metal. This permits this end of the each board to be insertable into the opening of a magnetic resonance tomography scanner or a computed tomography scanner without disturbing their operation (by interaction with magnetic fields by x-ray absorption or the like). A further advantage is that—proceeding on the basis of a known examination and/or treatment device with a scanner board firmly attached—the board on the side that cooperates with the support of introduction mechanism of the scanner does not have to be changed, at least not substantially. This is of significance with regard to retrofitting existing medical examination and/or treatment devices. Furthermore, there is the advantage that, given attachment of the board to one end of the gurney, the gurney can be fashioned such that obstruction to hospital personnel is prevented, meaning that the patient is optimally accessible.

In the gurney, a first cantilevered bracket or arm as a support component to support the board and a second cantilevered bracket or arm to couple the board can be provided.

The second arm preferably is fashioned such that the board in the connected state comes to lie underneath the second arm. In particular, the second arm is fashioned for suspended acceptance of the board. It is convenient for the second arm to have coupling that produces a firm, releasable connection with the board. Such a coupling can be realized in a simple manner, for example by a latch or snap mechanism.

In contrast, such a rigid connection to the board in the support component at the first arm is omitted in the gurney according to the invention. The first arm is preferably fashioned such that the board can still be moved upwardly. This provides the advantage that the attachment of the board to the gurney is simplified for hospital personnel. A further advantage is that a coupling device that (in particular if it is manufactured of metal) could disrupt the imaging in an examination device is not mandatory at the head end of the board, i.e. on the side of the first arm.

The arms preferably are removable from the chassis and exchangeable with one another. For example, the rear arm can be attached to the front position, and the front arm can be attached to the rear position, so the advantage arises that the gurney can optionally approach a patient positioning device from the left or right, and in each case it is ensured that the gurney can be turned so the first arm is closer to the examination region of an examination device, for example the opening of a magnetic resonance tomography scanner.

In a preferred embodiment, separate contact surfaces for creating the positive fit are present at the support component for each of the boards. The contact surfaces respectively can be planar or curved, and can be hard or provided with a soft coating.

In a preferred embodiment, the support component has a movable seated part that can be adjusted with regard to its position and/or its alignment so that in a first position it produces the positive fit to one of the different boards, and in a second position the support component is ready to accept another board.

The movable seated part has a contact surface for at least one of the boards. For example, the movable seated part can be adapted (matched) to the underside of a matching board, such that it can be fastened with a positive fit.

Preferably one of the boards is (at least in sections) a narrow board, in particular a board for an angiography x-ray device, and the support component has two lowerable guiding jaws that are separated from each other by a spacing matched to the width of the (preferably planar) narrow board. The sides of the guiding jaws turned facing one another are (acting as contact surfaces), are matched to the shape (in particular beveled) of the side surfaces of the narrow board. The guiding jaws can be considered as a movable seated part in the sense described above.

In another preferred embodiment, one of the boards is a curved board, in particular a board for a computed tomography device, and the support component has a recess that is adapted to the board in terms of its width and/or shape. For example, only the width of the recess is matched to the width of the curved board. The recess, for example, can be adapted in the base region to the shape of the curved board. The recess, for example, can be adapted to the underside of the board, however, the recess alternatively have an open bottom.

The curved board preferably represents a second board type of the narrow board, for which the gurney is likewise fashioned for a positive fit.

Preferably a based part to support the narrow board can be lowered, such that the recess to accept the curved board is free.

In another preferred embodiment, one of the boards is a universal board, in particular a board for an x-ray fluoroscopy system or x-ray exposure system, and the support component has a depression that is fitted to the universal board with regard to width and/or shape. The depression alternatively can have an open bottom.

The (preferably planar) universal board preferably represents a third board type of the narrow board and the curved board, for which the gurney is additionally fashioned for a positive fit.

The depth of the depression for the universal board preferably is smaller than the depth of the recess, and its width preferably is greater than the width of the recess, measured from an upper edge as a common reference point.

For example, the depression for the universal board has positionally rigid contact surfaces on the edge side with a shape is adapted to the (in particular planar) underside of the universal board.

In another preferred embodiment, the gurney has a sensor device that upon contact with one of the preferred embodiments (dependent on its type) undertakes an unlatching or latching with a support component that enables the acceptance and fastening of the board.

In particular, the sensor device interacts with the support component via a mechanical linkage.

The sensor device can be a sensor arranged such that, upon transfer of at least one of the boards from a medical examination and/or therapy device, it comes in contact with this board, and is thereby deflected or otherwise activated. The movement of the sensor can then affect the unlatching and latching in the support component, for example via the mechanical linkage.

Dependent on the height of the lower edge of the board above the floor, the sensor preferably is deflected a variable distance or (is variably activated). This is of particular relevance in the event that the height of the lower edge of the board above the floor is different for different medical examination and/or therapy devices to be approached by the gurney. This allows the gurney is “pick up”, i.e. accept different boards at heights different from one another i.e., the narrow board and the curved board, or the narrow board and the universal board, or the curved board and the universal board, or any combination of these boards, in the device pertaining to the respective board. The sensor is then, for example, preset to be activated at two or three different heights, i.e. distances of the boards from the floor, such that a different effect can be exercised on the support component within a known tolerance range for each of these heights.

Given an operation of the sensor device, a release can be effected for motion of the movably mounted part described above.

For example, given an operation of the sensor device, a release can be effected to lower the guiding jaws and/or the base part.

In a further embodiment the two booms, and in particular the support component, are respectively attached at the ends of a telescope columns. It is thereby possible to adapt the gurney upon transfer to or from one of the examination and/or treatment devices at the respective positioning heights of the appertaining examination and/or treatment devices. The gurney according to the invention thus can be used at different device heights so that it is universally suitable for examination and/or treatment devices of several different types.

Upon picking up a board from a particular medical examination or therapy device, the support component is adjusted for this purpose to a defined, predetermined height above the floor. This can ensue manually, whereby either the determined heights are indicated via markings on the gurney or/and an indication device is present to continually read out the current height of the support component. Furthermore, specified heights can be set by a latching mechanism.

To assist the operating personnel, a motor can be provided to change the height of the support component that, for example, can operate one of the aforementioned telescopic columns.

In this embodiment a memory is provided in which different height positions of the support component are stored, as well as an output device, that positions the support component in one of the stored height positions, dependent on an input entered by an input device.

The stored heights are, for example, the aforementioned different “transfer heights,” which are necessary or desired for the different medical examination or therapy devices. With the entry via the input device, for example, the type of the board and/or the type of the medical examination or therapy device can be selected.

The boards preferably are appropriate for supporting the patient during an examination by means of medical device employing x-ray imaging. They are thus in particular (at least in certain areas) radiation-transparent and, for example, produced from carbon fiber-reinforced plastic (CFP).

The invention also includes a patient transport system having at least one gurney and at least two boards of different types that are coupleable to the gurney.

### DESCRIPTION OF THE DRAWINGS

FIG. 1 shows a gurney according to the invention in a perspective overall view.

FIG. 2 shows an embodiment for a connection mechanism in an arm of the gurney of FIG. 1.

FIG. 3 shows a first variant of an arm for the gurney of FIG. 1 acting as a support component, with a narrow board.

FIG. 4 shows the variant of FIG. 3 with a curved board.

FIG. 5 shows a second variant of an arm for the gurney of FIG. 1 acting as a support component, with a universal board.

FIG. 6 shows the variant of FIG. 5 with a curved board.

FIG. 7 shows a third variant of an arm for the gurney of FIG. 1 acting as a support component, with a narrow board,

FIG. 8 shows the variant of FIG. 7 with a universal board.

FIG. 9 shows a fourth variant of an arm for the gurney of FIG. 1 acting as a support component.

FIG. 10 shows the variant of FIG. 9 in another operating state.

### DESCRIPTION OF THE PREFERRED EMBODIMENTS

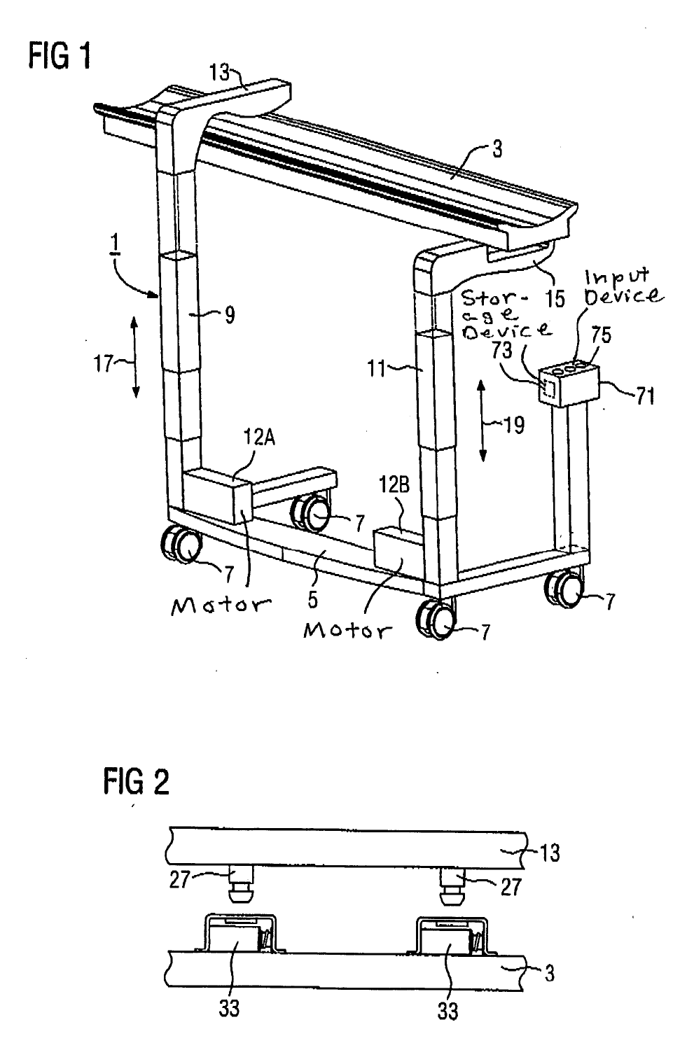

FIG. 1 shown a gurney 1 or transport carriage to accept a support or bed board 3 that is also known as a patient bearing plate. The transport carriage 1 has a U-shaped or C-shaped chassis 5 on which four double rollers 7 are mounted. Two of the double rollers 7 can be locked by the operation of a foot switch (not shown).

Telescopic columns 9, 11, whose height can be adjusted either manually or by drive motors 12A, 12B concurrently as well as independently of one another, are attached at the edge of the closed side of the chassis 5. The telescopic columns 9, 11 respectively support horizontal arms 13 and 15. The arms 13, 15 serve to accept a board 3. The first arm 15 supports the board 3 and the second arm 13 engages it from above.

Because the telescopic columns 9, 11 can be extended respectively along the vertical directions 17 and 19 independently of one another, different boards 3 with different thicknesses can be transported with the transport carriage 1, even though the second arm 13 and the first arm 15 engage the board 3.

The first arm 15 and the second arm 13 are attached to the chassis 5 by means of identical plug connections (not shown), such that they can be exchanged with each other. For locking, for example, locking pins are present.

The gurney 1 and the board 3 are fashioned such that the head of the patient comes to lie at the first arm 15 and the patient's feet come to lie at the second arm 13.

The second arm 13 is fashioned to securely couple to the board 3. A possible coupling mechanism is shown in FIG. 2. The second arm 13 has a coupling element 27 that can be detachably, rigidly (with respect to position) coupled via corresponding coupling elements 33 to the top of the board 3. In the shown example, the coupling element 27 is a peg with a conical tip, with a ring groove arranged behind it. These pegs can be latched as a pair in the respective coupling elements 33, in which a spring-loaded pin engages the ring groove.

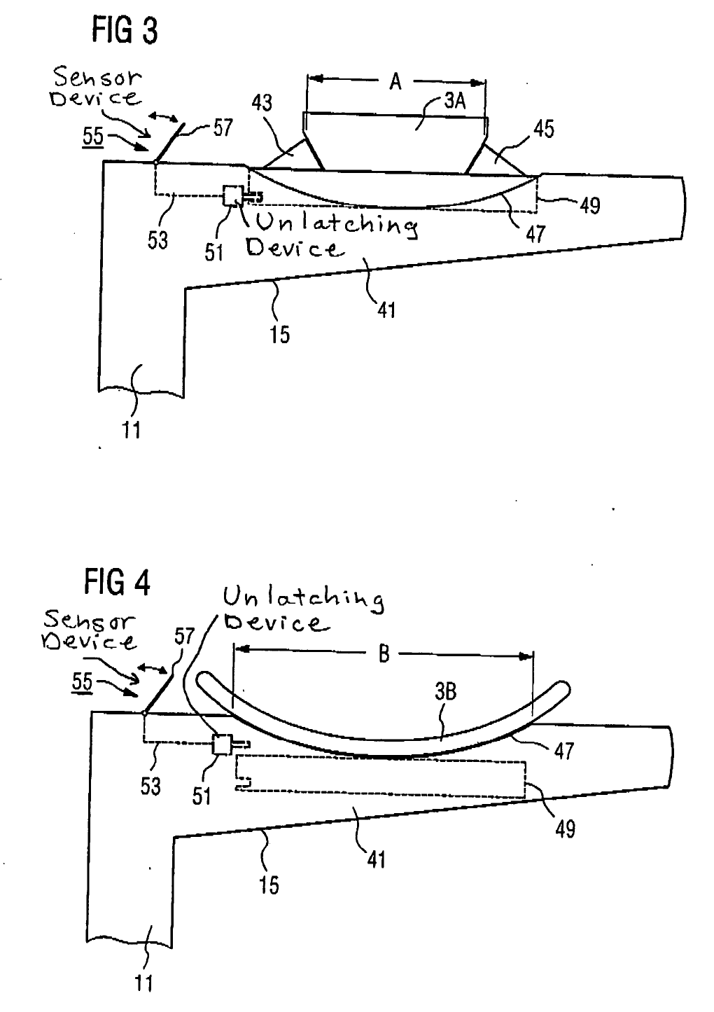

The first arm 15 is fashioned to support the board 3 and acts as a support component 41 in its upper region. The support component 41 is fashioned such that alternately a number of boards 3A, 3B, 3C of different shapes and/or of different widths (boards of different types) can be supportably fastened with a positive fit. Different variants of the support component 41 are subsequently explained on the basis of FIGS. 3 through 8.

A first variant of the support component 41 is shown in FIGS. 3 and 4. According to FIG. 3, two guiding jaws 43, 45 that can be raised and lowered are provided on the top of the first arm 15, as movably seated parts with a separation A (≈30 cm) matched to the width of the first board type. This board type is represented by a board 3A that tapers at the head end, and thus is narrow, for example a board for an angiography x-ray device. The guiding jaws 43, 45 are beveled on the respective inner sides (acting as contact surfaces) in the same manner as the narrow board 3A. The narrow board 3A is held with positive fit by the guiding jaws 43, 45, preventing lateral motion.

The support component 41 further has a basin or a recess 47 at its topside, which is adapted as a contact surface to the corresponding curved form of the underside of a board 3B of a second type (FIG. 4), and accepts the board 3B with a positive fit. The second type is a curved (at least on the underside) board 3B, for example a board 3B for a computed tomography device. The shape of the curved board 3B is shown in cross-section in FIG. 4. The curved board 3B is also secured against lateral movement in the position shown in FIG. 4. The width B of the recess 47 corresponds approximately to the width of the curved board 3B.

In the position shown in FIG. 3, the narrow board 3A lies on its underside on a planar base part 49 that likewise forms a movable seated part. In order for the curved board 3B, instead of the narrow board 3A, to be placed on the support component 41 by the medical personnel and fastened there with positive fit, the base part 49 can be lowered beneath the lower edge of the recess 47. In FIG. 4, it is retracted in the inside of the first arm 15.

When a board of the second type, i.e., the curved board 3B is placed on the support component 41, its underside initially presses on the guiding jaws 43, 45. These are positioned such that they can be pressed downwardly given a force ensuing from above coming from the curved board 3B. As a result they remain positionally rigid upon impact with a force ensuing primarily from the side coming from the narrow board 3A. After the guiding jaws 43, 45 are pressed downwardly, the underside of the curved board 3B then presses against the base part 49 that is likewise pressed downwardly, such that the recess 47 is free to receive the curved board 3B.

So that the base part 49 is not also pushed downwardly upon placement of a board of the first type on the support component 41, thus the narrow board 3A, the base part 49 remains locked until it is unlocked by an unlatching device (schematically shown). The unlatching device engaging the base part 49 via a bolt is connected to a mechanical sensor device 55 via a linkage 53 (schematically indicated by a dashed line). A lever or sensor of the sensor device 55 recognizes the type of board and, after recognition of the curved board 3B, releases the lock of the component 49 into which the bolt is retracted.

The recognition of the type of board is made on the basis of the assembly height of the narrow angiography board 3A being larger than the assembly height of the curved computed tomography board 3B. The length of the sensor 57 is therefore measured such that the sensor 57, is only actuated upon transfer of the curved board 3B from a computer tomography device, and not upon transfer of a board from an angiography system.

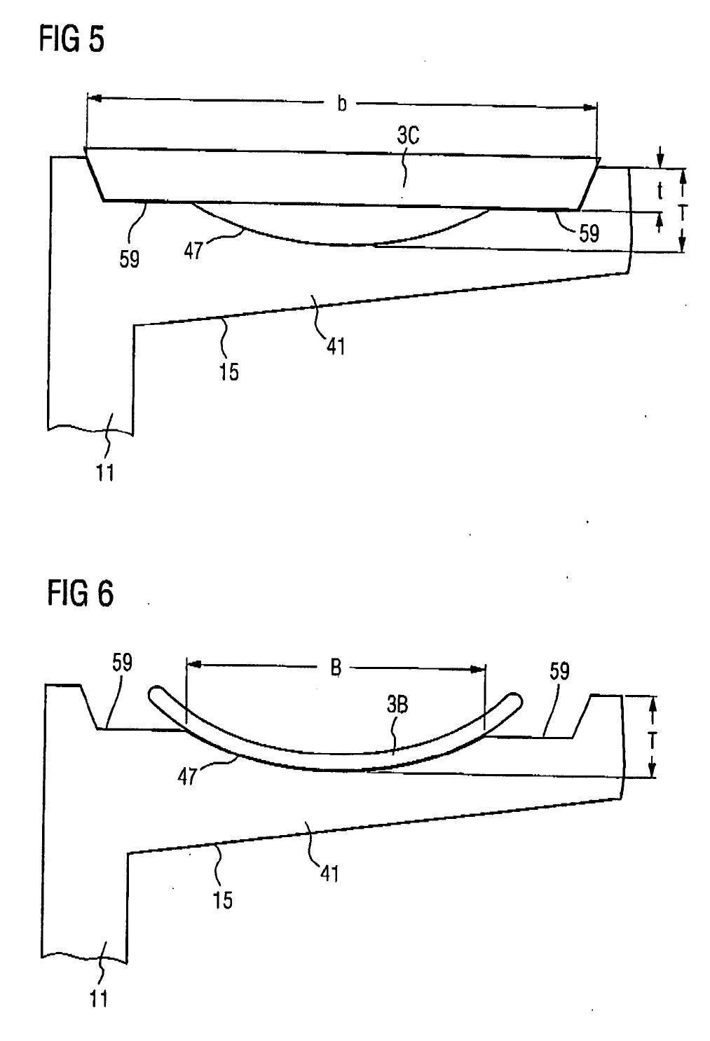

In the FIGS. 5 and 6, a second variant of a gurney 1 according to the invention is shown with a support component 41 different than in FIGS. 3 and 4. This support component 41 is fashioned for fastening with a positive fit a wide and planar universal board 3C (see FIG. 5) as well as for fastening with a positive fit a curved board 3B for a computed tomography device. As in the first variant, a curved depression 47 is present for positioning the curved board 3B with a positive fit. Furthermore, a curved depression 59 concentric to the recess 47 is present that is fitted as to width b and in the shape of its sidewalls, to the universal board 3C for fastening the universal board 3C, and acts as a contact surface for it. The depth t of the depression 59 is smaller than the depth T of the recess 47 and the width b (>>80 cm) of the depression 59 is larger than the width B (>>40 cm) of the recess 47. The universal board 3C comes to rest in the depression 59 next to the recess 47, which it bridges unsupported. In this second variant, movable seated parts are not used to realize the positive fit with the two different boards 3B, 3C, nor is a sensor device as in the first variant necessary.

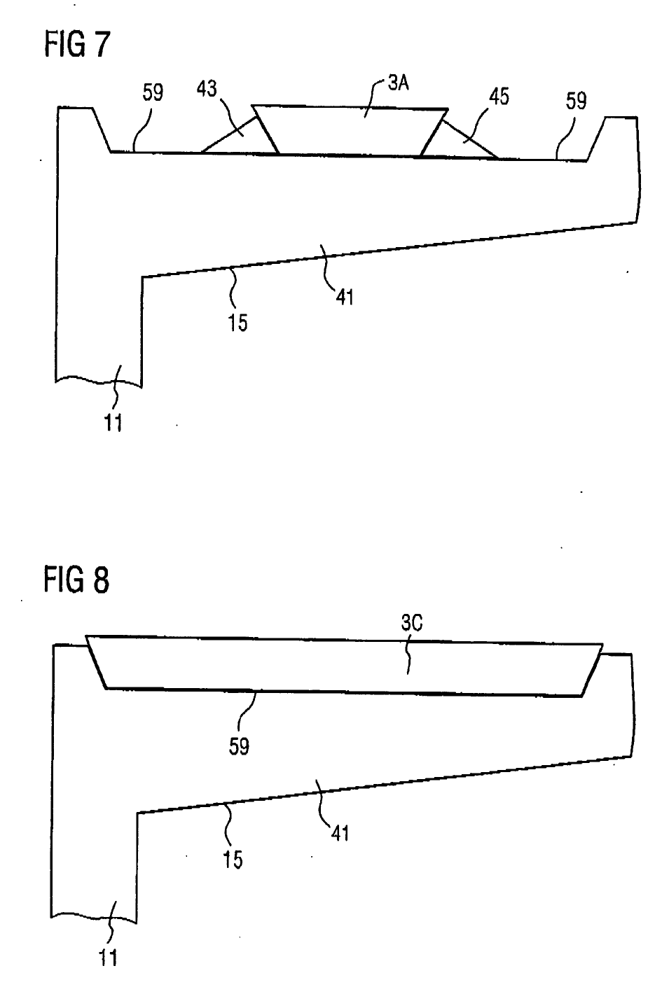

FIGS. 7 and 8, the third variant of the gurney 1 according to the invention is fashioned to accept with a positive fit the narrow board 3A and the wider universal board 3C. As in the first variant (FIG. 3), guiding jaws 43, 45 that can be lowered down are present to fasten the narrow board 3A. These guiding jaws 43, 45 can be lowered under the influence of the planar wider universal board 3C (see FIG. 8), such that the positive-fit depression 59 present for the universal board 3C is free to accept the universal board 3C. With suitable positioning of the guiding jaws 43, 45 as is specified in connection with the first variant, a sensor device as was specified in connection with the first variant is not mandatory.

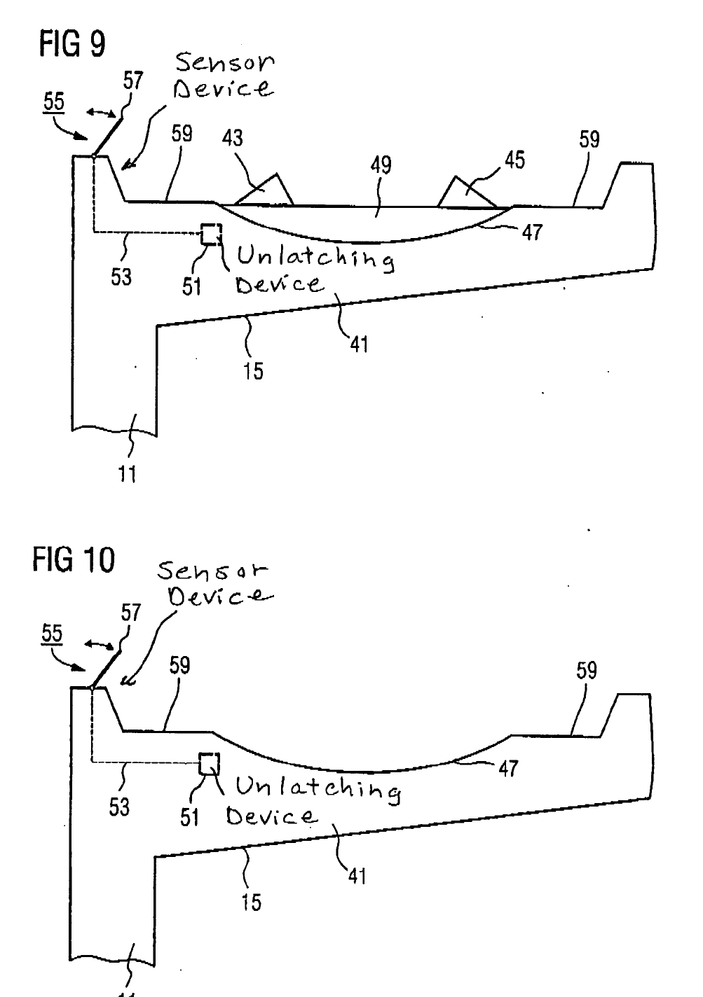

In FIGS. 9 and 10, a fourth variant of a support component 41 for a gurney 1 according to the invention is shown which is appropriate for positive-fit acceptance and fastening of all three boards 3A, 3B, 3C. This variant is a combination of the three previously described variants.

The narrow board can be held by the base part 49 between the guiding jaws 43, 45 that can be lowered, and fastened with a positive fit. With lowered guiding jaws 43, 45 and a lowered base part 49 (see FIG. 10), the curved board 3B can be fastened by the curved recess 47, or the wider universal board 3C can be fastened by the wider depression 59. To unlatch the floor base 49, and optionally also to unlatch the guiding jaws 43, 45, a sensor device 55 and an unlatching device 51 are present as specified in connection with the FIGS. 3 and 4.

The measurement by the sensor 57 on the sensor device 55 is based on the fact that the boards 3A, 3B, 3C are transferred at different device-specific and predetermined heights at the device-side before they are transferred from the respective examination or treatment devices. Before transfer of one of the boards 3A, 3B, 3C from a particular medical device, the gurney 1, in particular the support component 41 with the sensor device 55, is brought to a specific, predetermined approach height (position height) with respect to the medical device. The approach height is thereby measured with regard to the floor of the examination room in which the gurney 1 located. Due to the different heights of the board in the individual medical devices and the predefined approach heights, the different heights of the lower edge of the boards 3A, 3B, 3C above the floor are used as a criterion for a different operation or actuation of the sensor 57.

To ease the setting of a defined starting height, a housing 71 is present (as shown in FIG. 1) on the chassis 5 of the gurney 1 in which an electronically readable storage device 73 is integrated, in which different position heights of the support component 41 are stored. In addition, an input device 75 is integrated in the housing 71, having three operating buttons with which operating personnel can select one of three different examination devices, namely an angiography device, a computed tomography device, or an x-ray fluoroscopy device. Dependent on the input entered by the operating personnel at the input device 75, the support component 41 is automatically driven by the motors 21A, 21B to the appropriate height, by suitable control software using the appertaining heights stored in the storage device 73.

At the foot end, all of the boards 3A, 3B, 3C belonging to the gurney 1 are provided with the same coupling mechanism to the second arm 13, in particular according to FIG. 2.

The invention can be used for four or more board types, for example with contact surfaces and/or movable seated parts arranged following one another for the different types as seen in the direction of the patient axis.

Although modifications and changes may be suggested by those skilled in the art, it is the intention of the inventors to embody within the patent warranted hereon all changes and modifications as reasonably and properly come within the scope of their contribution to the art.

We claim as our invention:

1. A patient gurney comprising:
a chassis;
a support component on said chassis, said support component having a positive fit mechanism adapted to interact with a patient support board adapted for placement on said support component to prevent lateral motion of said patient support board, said positive fit mechanism being releasable to allow removal of said patient support board by a patient support arrangement of a medical device; and
said support component and said positive fit mechanism being automatically variably configurable to receive and engage any of a plurality of types of patient support boards, each having a head end and an underside, and differing from each other as to at least one of a shape of the underside and a width of the head end.

2. A patient gurney as claimed in claim 1 wherein said support component and said positive fit mechanism are automatically variably configurable, dependent on a patient support board placed thereon, to present a different contact surface, adapted to produce a positive fit with the type of patient support boards placed thereon, that is different for each of said types of patient support board.

3. A patient gurney as claimed in claim 1 wherein said support component comprises a movably mounted part that is adjustable as to at least one of position and alignment, so as to assume a first position for making a positive fit with a first of said different types of patient support boards, and to assume a second position to accept another of said type of patient support boards.

4. A patient gurney as claimed in claim 3 comprising a sensor device adapted to interact with a patient support board placed on said support component to recognize which of said type of patient support boards is placed on the support component, said sensor device retracting the movably mounted part if said sensor recognizes that the type of the patient support board placed on the support component does not require said movably mounted part for acceptance thereof.

5. A patient gurney as claimed in claim 1 wherein one of said types of said patient support boards has a narrow width at said head end, and wherein said positive fit mechanism comprises two guiding jaws that are each retractable into the support component, said guiding jaws being spaced from each other adapted to the narrow width.

6. A patient gurney as claimed in claim 5 comprising a sensor device adapted to interact with a patient support board placed on said support component to recognize which of said types of patient support boards is placed on the support component, said sensor device releasing the guiding jaws if said sensor recognizes that the type of the patient support board placed on the support component does not require said guiding jaws for producing said positive fit.

7. A patient gurney as claimed in claim 5 wherein each of said guiding jaws has a side adapted to face said head end of said one of said types of said patient support boards having a narrow width at the head end, and wherein each of said sides of said guiding jaws has a shape adapted to conform to a side surface of the one of said types of said patient support boards having a narrow width at the head end.

8. A patient gurney as claimed in claim 5 wherein one of said types of said patient support boards is a patient support board with a curved underside, and wherein said support component has a recess having at least one of a width and a shape conforming to the curved underside.

9. A patient gurney as claimed in claim 8 wherein said support component comprises a base part adapted to support said one of said types of said patient support boards having a narrow width at the head end, said base part being retractable into said support component to free said recess for accepting said curved underside.

10. A patient gurney as claimed in claim 9 comprising a sensor device adapted to be actuated by a patient support board placed on said support component to identify which of said types of patient support boards is placed on the support component, said sensor device, upon recognizing said type as being a patient support board with a curved underside, automatically causing retraction of said base part to free said recess.

11. A patient gurney as claimed in claim 9 wherein one of said types of said patient support boards is a universal patient support board and wherein said support component has a depression therein adapted as to at least one of width and shape to conform to said universal patient support board.

12. A patient gurney as claimed in claim 11 wherein said depression has a depth that is smaller than a depth of said recess, and a width that is larger than a width of said recess.

13. A patient gurney as claimed in claim 1 wherein one of said types of said patient support boards is a patient support board with a curved underside, and wherein said support component has a recess having at least one of a width and a shape conforming to the curved underside.

14. A patient gurney as claimed in claim 1 wherein one of said types of said patient support boards is a universal patient support board and wherein said support component has a depression therein adapted as to at least one of width and shape to conform to said universal patient support board.

15. A patient gurney as claimed in claim 1 comprising a sensor device adapted to interact with a patient support board placed on the support component to recognize which of said types of patient support boards is placed on the support component, said sensor device automatically causing said support component and said positive fit mechanism to be configured to receive the patient support board placed on the support component.

16. A patient gurney as claimed in claim 15 wherein said sensor device interacts with the patient support board placed on the support component by mechanical contact with the patient support board placed on the support component, said mechanical contact actuating said sensor device.

17. A patient gurney as claimed in claim 16 wherein said chassis is adapted for placement on a floor, and wherein each of the types of said patient support boards has a lower edge, and wherein said sensor device comprises a sensor that is deflected a variable distance dependent on a height above the floor of the lower edge of a patient support board placed on the support component.

18. A patient gurney as claimed in claim 1 wherein said support component is mounted to said chassis so as to be adjustable in height.

19. A patient gurney as claimed in claim 18 further comprising a motor in driving engagement with said support component to adjust the height of said support component.

20. A patient gurney as claimed in claim 19 further comprising a storage device in which a plurality of different heights of said support component are stored, and an input device connected to said storage device allowing input of a selected one of said different position heights, to automatically cause said motor to adjust the height of the support component to the selected one of said position heights.

21. A patient gurney system comprising:
a plurality of different types of patient support boards each having a head end and an underside, and differing from each other as to at least one of a shape of the underside and a width of the head end;
a chassis;
a support component on said chassis, said support component having a positive fit mechanism adapted to interact with a patient support board placed on said support component to prevent lateral motion of said patient support board, said positive fit mechanism being releasable to allow removal of said patient support board by a patient support arrangement of a medical device; and
said support component and said positive fit mechanism being automatically variably configurable to receive and engage any of the plurality of the patient support boards.

22. A patient gurney system as claimed in claim 21 wherein said support component and said positive fit mechanism are automatically variably configurable, dependent on a patient support board placed thereon, to present a different contact surface, adapted to produce a positive fit with the types of said patient support boards placed thereon, that is different for each of said types of patient support board.

23. A patient gurney system as claimed in claim 21 wherein said support component comprises a movably mounted part that is adjustable as to at least one of position and alignment, so as to assume a first position for making a positive fit with a first of said different types of patient support boards, and to assume a second position to accept another of said types of patient support boards.

24. A patient gurney system as claimed in claim 23 comprising a sensor device adapted to interact with a patient support board placed on said support component to recognize which of said types of the patient support boards is placed on the support component, said sensor device retracting the movably mounted part if said sensor recognizes that the type of the patient support board placed on the support component does not require said movably mounted part for acceptance thereof.

25. A patient gurney system as claimed in claim 21 wherein one of said types of patient support boards has a narrow width at said head end, and wherein said positive fit mechanism comprises two guiding jaws that are each retractable into the support component, said guiding jaws being spaced from each other adapted to the narrow width.

26. A patient gurney system as claimed in claim 25 comprising a sensor device adapted to interact with a patient support board placed on said support component to recognize which of said types of patient support boards is placed on the support component, said sensor device releasing the guiding jaws if said sensor recognizes that the type of the patient support board placed on the support component does not require said guiding jaws for producing said positive fit.

27. A patient gurney system as claimed in claim 25 wherein each of said guiding jaws has a side adapted to face said head end of said one of said types of said patient support boards having a narrow width at the head end, and wherein each of said sides of said guiding jaws has a shape adapted to conform to a side surface of said one of said types of said patient support boards having a narrow width at the head end.

28. A patient gurney system as claimed in claim 25 wherein one of said types of said patient support boards is a patient support board with a curved underside, and wherein said support component has a recess having at least one of a width and a shape conforming to the curved underside.

29. A patient gurney system as claimed in claim 28 wherein said support component comprises a base part adapted to support said one of said types of said patient support boards having a narrow width at the head end, said base part being retractable into said support component to free said recess for accepting said curved underside.

30. A patient gurney system as claimed in claim 29 comprising a sensor device adapted to be actuated by a patient support board placed on said support component to identify which of said type of patient support board placed on the support component, said sensor device, upon recognizing said type as being a patient support board with a curved underside, automatically causing retraction of said base part to free said recess.

31. A patient gurney system as claimed in claim 29 wherein one of said types of said patient support boards is a universal patient support board and wherein said support component has a depression therein adapted as to at least one of width and shape to conform to said universal patient support board.

32. A patient gurney system as claimed in claim 31 wherein said depression has a depth that is smaller than a depth of said recess, and a width that is larger than a width of said recess.

33. A patient gurney system as claimed in claim 21 wherein one of said types of said patient support boards is a patient support board with a curved underside, and wherein said support component has a recess having at least one of a width and a shape conforming to the curved underside.

34. A patient gurney system as claimed in claim 21 wherein one of said types of said patient support boards is a universal patient support board and wherein said support component has a depression therein adapted as to at least one of width and shape to conform to said universal patient support board.

35. A patient gurney system as claimed in claim 21 comprising a sensor device adapted to interact with a patient support board placed on the support component to recognize which of said types of patient support boards is placed on the support component, said sensor device automatically causing said support component and said press fit mechanism to be configured to receive the patient support board placed on the support component.

36. A patient gurney system as claimed in claim 35 wherein said sensor device interacts with the patient support board placed on the support component by mechanical contact with the patient support board placed on the support component, said mechanical contact actuating said sensor device.

37. A patient gurney system as claimed in claim 36 wherein said chassis is adapted for placement on a floor, and wherein each of said types of said patient support boards has a lower edge, and wherein said sensor device comprises a sensor that is deflected a variable distance dependent on a height above the floor of the lower edge of the patient support board placed on the support component.

38. A patient gurney system as claimed in claim 21 wherein said support component is mounted to said chassis so as to be adjustable in height.

39. A patient gurney system as claimed in claim 38 further comprising a motor in driving engagement with said support component to adjust the height of said support component.

40. A patient gurney system as claimed in claim 39 further comprising a storage device in which a plurality of different heights of said support component are stored, and an input device connected to said storage device allowing input of a selected one of said different position heights, to automatically cause said motor to adjust the height of the support component to the selected one of said position heights.

41. A patient gurney system as claimed in claim 21 wherein at least one of said types of said patient support boards has at least a region that is transparent to x-rays.
